(19) United States
(12) Patent Application Publication
(10) Pub. No.: US 2024/0207966 A1
(43) Pub. Date: Jun. 27, 2024

(54) WELDING SYSTEM, WELDING METHOD, WELDING ROBOT, AND PROGRAM

(71) Applicant: Kabushiki Kaisha Kobe Seiko Sho (Kobe Steel, Ltd.), Kobe-shi (JP)

(72) Inventors: Yoshiya TAKEMURA, Fujisawa-shi (JP); Shigeto TAKADA, Fujisawa-shi (JP); Atsushi FUKUNAGA, Fujisawa-shi (JP); Yasuharu SAKURAI, Fujisawa-shi (JP)

(73) Assignee: Kabushiki Kaisha Kobe Seiko Sho (Kobe Steel, Ltd.), Kobe-shi (JP)

(21) Appl. No.: 18/556,273

(22) PCT Filed: Mar. 25, 2022
(86) PCT No.: PCT/JP2022/014703

§ 371 Date: Oct. 19, 2023

(30) Foreign Application Priority Data
Apr. 20, 2021 (JP) 2021-071100

(51) Int. Cl. B23K 9/12; B23K 9/095; B25J 11/00

(52) U.S. Cl. CPC B23K 9/12; B23K 9/0953; B25J 11/005

(57) ABSTRACT

A welding system includes: a welding robot having a movable portion that can move integrally with a welding torch; a control device that controls movement of the welding robot; and a temperature sensor that is attached to the movable portion and measures an interpass temperature of an object to be welded present on a measurement axis in a noncontact manner. A central axis of the welding torch and the measurement axis of the temperature sensor are in a relation of three-dimensionally intersecting in a space, and a position where the central axis and the measurement axis three-dimensionally intersect is ahead of a tip end of the welding torch on the central axis of the welding torch. The control device controls movement of the welding torch such that the measurement axis is positioned at a measurement position of the temperature calculated in advance.

### TECHNICAL FIELD

The present invention relates to a welding system, a welding method, a welding robot, and a program.

### BACKGROUND ART

Nowadays, welding robots are used in many fields, and automation of welding work is in progress. In a case of welding a groove with multiple layers, measurement of an interpass temperature may be required. An interpass temperature is a temperature of a weld metal and an adjacent base metal (hereinafter, referred to as a “workpiece” or an “object to be welded”) immediately before welding a next pass in multilayer welding.

### CITATION LIST

### Patent Literature

Patent Literature 1: JP2008-275482A

### SUMMARY OF INVENTION

### Technical Problem

In a case where a temperature sensor is attached to an upper surface of a torch clamp that can move integrally with a welding torch as in Patent Literature 1, it is necessary to move the welding torch such that the welding torch is not positioned between the temperature sensor and a specific position (hereinafter, referred to as a “measurement point”) on the weld metal or a workpiece adjacent thereto every time the interpass temperature is measured. In this case, in order to avoid interference between the welding torch and the workpiece, an operation of separating the welding torch from the workpiece, an operation of moving the welding torch to direct the temperature sensor to the workpiece, and an operation of adjusting the welding torch to a position at which the temperature sensor measures the interpass temperature are required, and thus a time required for preparation for measurement becomes long.

An object of the present invention is to reduce a risk of interference between a welding robot and surrounding members before a temperature measuring device is disposed at a measurement position for measuring an interpass temperature, and to realize a reduction in a time until the temperature measuring device is disposed.

### Solution to Problem

With this object in view, according to one aspect of the present invention, there is provided a welding system including: a welding robot having a movable portion that can move integrally with a welding torch; a control device that controls movement of the welding robot; and a temperature sensor that is attached to the movable portion and measures an interpass temperature of an object to be welded present on a measurement axis in a noncontact manner, in which a central axis of the welding torch and the measurement axis of the temperature sensor are in a relation of three-dimensionally intersecting in a space, a position where the central axis of the welding torch and the measurement axis of the temperature sensor three-dimensionally intersect is ahead of a tip end of the welding torch on the central axis of the welding torch, and the control device controls movement of the welding torch such that the measurement axis of the temperature sensor is positioned at a measurement position of the interpass temperature calculated in advance.

It is preferable that the control device referred to herein further includes a calculation unit that calculates the measurement position based on data related to a shape of the object to be welded.

It is desirable that the welding system further includes an openable protection mechanism that covers the temperature sensor during welding and exposes at least a light receiving portion during measurement of the interpass temperature, and/or an ejection mechanism that ejects air for cleaning the light receiving portion of the temperature sensor.

It is desirable that the control device further includes a setting unit that sets a threshold value to be used for management of the interpass temperature at the measurement position, and a determination unit that determines whether the interpass temperature measured by the temperature sensor exceeds the threshold value, and the control device executes at least one or more of waiting for a start of a next pass, cooling of the object to be welded, or execution of work different from the next pass in a case where the measured interpass temperature exceeds the threshold value, and then instructs resumption of the next pass in a case where the interpass temperature measured again is equal to or lower than the threshold value.

It is desirable that in a case where the determination unit determines that the measured interpass temperature is equal to or lower than the threshold value, data related to measurement including the measured interpass temperature is recorded in a storage unit.

It is desirable that the control device instructs measurement of the interpass temperature at the measurement position only immediately before a specific pass.

It is desirable that the control device compares data related to a shape of the object to be welded and welding condition data in the past which are recorded in advance with data related to the shape of the object to be welded and welding condition data which are at current, determines a timing of measurement of an interpass temperature related to a specific pass, and instructs the measurement of the interpass temperature.

It is desirable that the control device further includes a prediction unit that, in a case where the determination unit determines that the measured interpass temperature exceeds the threshold value, compares at least one of data related to the measurement, data related to the shape of the object to be welded, or welding condition data in the past which are recorded in advance with at least one of data related to the measurement, data related to the shape of the object to be welded, or welding condition data which are newly recorded in a current measurement, and in a case where a waiting time or a cooling time can be predicted based on a comparison result, predicts the waiting time required for natural cooling and instruct to wait until the start of a next pass, or predicts the cooling time required and instruct to cool the object to be welded, or, instructs to execute work different from the next pass in a case where the predicted waiting time or the predicted cooling time is equal to or longer than a certain period of time.

It is desirable that in a case where the determination unit determines that the measured interpass temperature exceeds the threshold value, the determination unit calculates a value of a difference between the measured interpass temperature and the threshold value, and determines and instructs which of waiting for the start of the next pass, cooling of the object to be welded, and work different from the next pass is to be executed according to the calculated value of the difference. It is desirable that the movable portion is coupled to a tip end portion of an arm having a plurality of drive shafts.

According to another aspect of the present invention, there is provided a welding robot including: a movable portion that can move integrally with a welding torch; and a temperature sensor that is attached to the movable portion and measures an interpass temperature of an object to be welded present on a measurement axis in a noncontact manner, in which a central axis of the welding torch and the measurement axis of the temperature sensor are in a relation of three-dimensionally intersecting in a space, and a position where the central axis of the welding torch and the measurement axis of the temperature sensor three-dimensionally intersect is ahead of a tip end of the welding torch on the central axis of the welding torch.

According to still another aspect of the present invention, there is provided a welding method including: a process of measuring an interpass temperature at a measurement position using the above-described welding system; a process of continuing a next pass in a case where the measured interpass temperature is equal to or lower than a threshold value; and a process of measuring the interpass temperature at the measurement position one or more times after a predetermined time elapses in a case where the measured interpass temperature exceeds the threshold value, and instructing to start the next pass after the measured interpass temperature becomes equal to or lower than the threshold value.

Further, according to another aspect of the present invention, there is provided a program for causing a computer to realize a function of measuring an interpass temperature at a measurement position using the above-described welding system, a function of continuing a next pass in a case where the measured interpass temperature is equal to or lower than a threshold value, and a function of measuring the interpass temperature at the measurement position one or more times after a predetermined time elapses in a case where the measured interpass temperature exceeds the threshold value, and instructing to start the next pass after the measured interpass temperature becomes equal to or lower than the threshold value.

### Advantageous Effects of Invention

According to the present invention, it is possible to reduce a risk of interference between a welding robot and surrounding members before a temperature measuring device is disposed at a measurement position for measuring an interpass temperature, and to realize a reduction in a time until the temperature measuring device is disposed.

### BRIEF DESCRIPTION OF DRAWINGS

FIG. 1 is an overall view of a welding system of the present embodiment.

FIG. 2A is an enlarged view of portions including a tool portion and a temperature measuring device in a welding robot in a reference posture as viewed from a Y-axis direction, and is a side view as viewed from an attachment surface side of the temperature measuring device.

FIG. 2B is an enlarged view of the portions including the tool portion and the temperature measuring device in the welding robot in the reference posture as viewed from the Y-axis direction, and is a perspective view of the attachment surface side of the temperature measuring device as viewed from an obliquely front side with respect to an X axis.

FIG. 3 is an enlarged plan view of the portions including the tool portion and the temperature measuring device in the welding robot in the reference posture as viewed from a Z-axis direction.

FIG. 4A is another view illustrating a positional relation between a central axis of a welding torch and a measurement axis of a temperature sensor, and is a side view of the portions including the tool portion and the temperature measuring device in the welding robot as viewed from the attachment surface side of the temperature measuring device.

FIG. 4B is another view illustrating the positional relation between the central axis of the welding torch and the measurement axis of the temperature sensor, and is a front view of a portion of the welding torch within the welding robot as viewed from the front.

FIG. 4C is another view illustrating the positional relation between the central axis of the welding torch and the measurement axis of the temperature sensor, and is a plan view of the portion of the welding torch within the welding robot as viewed from above.

FIG. 5 is a block diagram illustrating functions of a control device.

FIG. 6A is a view illustrating a position at which an interpass temperature is measured, and is a plan view of two workpieces to be welded as viewed from an upper surface.

FIG. 6B is a view illustrating the position at which the interpass temperature is measured, and is a side view of a groove as viewed from a side surface side.

FIG. 7 is a flowchart illustrating an example of operations of a process executed before welding by the welding system is started.

FIG. 8 is a flowchart illustrating an execution example of a welding operation using the welding system.

FIG. 9A is a view illustrating a positional relation between the workpiece and the welding torch or the like at the time when one pass is completed, and is a side view of the welding torch or the like as viewed from an attachment surface side of the temperature sensor.

FIG. 9B is a view illustrating the positional relation between the workpiece and the welding torch or the like at the time when one pass is completed, and is a plan view of the welding torch or the like as viewed from the upper surface.

FIG. 10A is a view illustrating adjustment of a position of the welding torch or the like in a case of measuring the interpass temperature, and is a side view of the welding torch or the like as viewed from the attachment surface side of the temperature sensor.

FIG. 10B is a view illustrating adjustment of the position of the welding torch or the like in the case of measuring the interpass temperature, and is a plan view of the welding torch or the like as viewed from the upper surface.

FIG. 11A is a view illustrating a positional relation between a workpiece and a welding torch or the like at a time when one pass is completed in a welding system of a comparative example, and is a side view of a welding torch or the like as viewed from the same side as FIG. 9A.

FIG. 11B is a view illustrating the positional relation between the workpiece and the welding torch or the like at the time when one pass is completed in the welding system of the comparative example, and is a plan view of the welding torch or the like as viewed from the upper surface.

FIG. 12A is a view illustrating adjustment of a position of the welding torch or the like in a case of measuring an interpass temperature by a welding system of a comparative example, and is a side view of a welding torch or the like as viewed from the same side as FIG. 10A.

FIG. 12B is a view illustrating the adjustment of the position of the welding torch or the like in the case of measuring the interpass temperature by the welding system of the comparative example, and is a plan view of the welding torch or the like as viewed from the upper surface.

FIG. 13A is a view illustrating an operation of directing a measurement axis of a temperature sensor to a position used for measuring the interpass temperature in a welding system of a comparative example, and is a side view of a welding torch or the like as viewed from the same side as FIG. 10A.

FIG. 13B is a view illustrating the operation of directing the measurement axis of the temperature sensor to the position used for measuring the interpass temperature in the welding system of the comparative example, and is a plan view of the welding torch or the like as viewed from the upper surface.

### DESCRIPTION OF EMBODIMENTS

Hereinafter, examples of embodiments of the welding system, the welding method, the welding robot, and the program according to the present invention will be described with reference to the accompanying drawings. Each of the drawings is created for describing the present invention, and the embodiments of the present invention are not limited to the illustrated contents.

### <Overall Configuration of System>

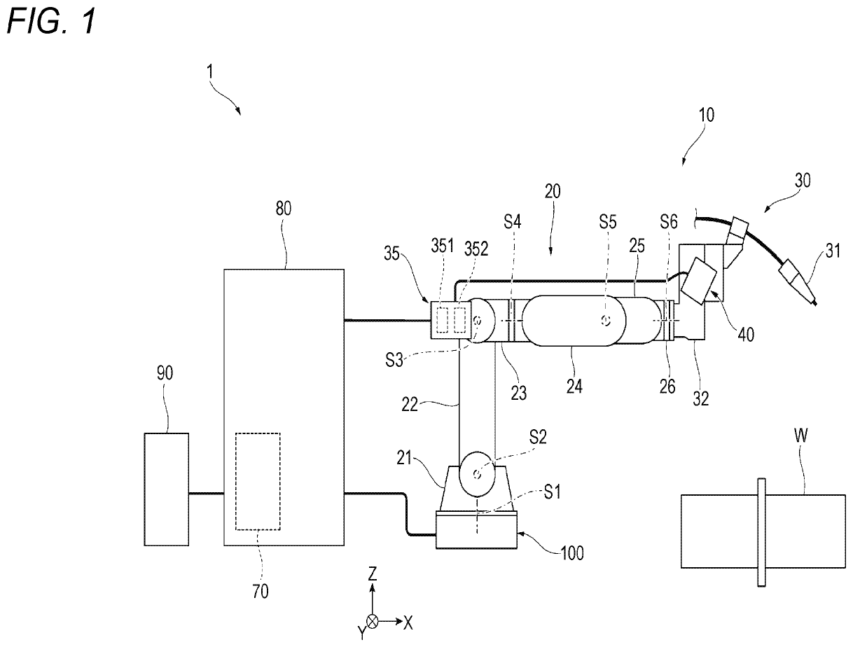

FIG. 1 is an overall view of a welding system 1 of the present embodiment.

As illustrated in FIG. 1, in the description of the present embodiment, a horizontal direction with respect to the ground refers to an X axis and a Y axis. The X axis and the Y axis are orthogonal to each other. In addition, a vertical direction refers to a Z axis. The Z axis is orthogonal to the X axis and the Y axis, respectively.

As illustrated in FIG. 1, the welding system 1 includes a welding robot 10 that welds workpieces W as an example of an object to be welded which is a welding target, an air compressor 70 as an example of a supply unit that supplies compressed air, a control device 80 that controls an operation of the welding robot 10, and a power supply 90 for supplying a welding current.

### <Welding Robot 10>

There are various types of welding robots 10 according to applications. In the description of the present embodiment, an example of the welding robot 10 used for welding a steel frame is used. In addition, the welding robot 10 of the present embodiment is an articulated robot. Further, the welding robot 10 of the present embodiment is a robot that performs arc welding on the workpiece W.

As illustrated in FIG. 1, the welding robot 10 includes a base portion 100, a movable manipulator portion 20, and a tool portion 30 mounted on the manipulator portion 20. Further, the welding robot 10 includes a relay box 35 that relays an electrical signal or the like to the control device 80 and relays compressed air from the air compressor 70, and a temperature measuring device 40 that measures a temperature.

### <Base Portion 100>

The base portion 100 is fixed to an installation target such as a floor. Further, the base portion 100 supports respective components of the welding robot 10 including the manipulator portion 20.

### <Manipulator Portion 20>

The manipulator portion 20 includes a turning portion 21, a lower arm portion 22, an upper arm portion 23, a wrist turning portion 24, a wrist bending portion 25, and a wrist rotating portion 26. In the following description, in a case where the turning portion 21, the lower arm portion 22, the upper arm portion 23, the wrist turning portion 24, the wrist bending portion 25, and the wrist rotating portion 26 are not distinguished, each of those is referred to as a “link portion”.

The turning portion 21 is connected to the base portion 100 via a first drive shaft S1 along the vertical direction. The turning portion 21 is turnable about the first drive shaft S1 with respect to the base portion 100.

The lower arm portion 22 is connected to the turning portion 21 via a second drive shaft S2 along the horizontal direction. The lower arm portion 22 is rotatable about the second drive shaft S2 with respect to the turning portion 21.

The upper arm portion 23 is connected to the lower arm portion 22 via a third drive shaft S3 along the horizontal direction. The upper arm portion 23 is rotatable about the third drive shaft S3 with respect to the lower arm portion 22.

The wrist turning portion 24 is connected to the upper arm portion 23 via a fourth drive shaft S4. The wrist turning portion 24 is rotatable about the fourth drive shaft S4 with respect to the upper arm portion 23.

The wrist bending portion 25 is connected to the wrist turning portion 24 via a fifth drive shaft S5 along the horizontal direction. The wrist bending portion 25 is rotatable about the fifth drive shaft S5 with respect to the wrist turning portion 24. The wrist rotating portion 26 is connected to the wrist bending portion 25 via a sixth drive shaft S6.

The wrist rotating portion 26 is rotatable about the sixth drive shaft S6 with respect to the wrist bending portion 25. The tool portion 30 is mounted on the wrist rotating portion 26 of the present embodiment.

The manipulator portion 20 moves each link portion using the first drive shaft S1 to the sixth drive shaft S6 as rotation centers, thereby moving a welding torch 31 to be described later of the tool portion 30 to any position with respect to the workpiece W.

Next, a reference posture of the welding robot 10 will be described. The reference posture in the present embodiment is a state in which rotation angles of the first drive shaft S1 to the sixth drive shaft S6 in the welding robot 10 are set to origin angles at which an angle formed with respect to a predetermined reference is 0 degrees.

In the present embodiment, the origin angles can be exemplified as angles at which the welding robot 10 is in the following states. For example, as illustrated in FIG. 1, the origin angle is an angle of the second drive shaft S2 at which the lower arm portion 22 is brought into a state of being along the vertical direction. Further, the origin angle is angles of the third drive shaft S3 and the fifth drive shaft S5 at which each of the upper arm portion 23 and the wrist bending portion 25 is brought into a state of being along the horizontal direction. Further, the origin angle is angles of the first drive shaft S1, the fourth drive shaft S4, and the sixth drive shaft S6 at which the second drive shaft S2, the third drive shaft S3, and the fifth drive shaft S5 are brought into a state of being parallel to each other.

### <Tool Portion 30>

The tool portion 30 includes the welding torch 31 that performs welding and a torch supporting portion 32 that supports the welding torch 31.

While feeding a welding wire, the welding torch 31 causes a current supplied from the power supply 90 to flow through the welding wire to form a weld bead on the workpiece W.

The torch supporting portion 32 holds the welding torch 31 at one end portion. In addition, the torch supporting portion 32 is connected to the wrist rotating portion 26 at the other end portion. The torch supporting portion 32 moves integrally with the wrist rotating portion 26. Further, the torch supporting portion 32 causes the welding torch 31 supported by the torch supporting portion 32 to be moved integrally with the wrist rotating portion 26.

In the welding robot 10 of the present embodiment, replacement is possible with a tool different from the above-described welding torch 31 in the tool portion 30. In the welding robot 10 of the present embodiment, instead of the welding torch 31 and the torch supporting portion 32, a slag chipper can be mounted on the wrist rotating portion 26 as the tool portion 30. The slag chipper is a tool for removing slag generated in the weld bead formed on the workpiece W. The slag chipper removes the slag generated in the weld bead by, for example, bringing a vibrating needle into contact with the weld bead.

### <Relay Box 35>

The relay box 35 includes an air control unit 351 and a temperature sensor amplifier 352.

In the present embodiment, compressed air is supplied from the air compressor 70 to a tool such as the slag chipper by a flow path of air (hereinafter, referred to as “air path”). In addition, the compressed air is supplied from the air compressor 70 to an air cylinder portion 60 to be described later through the air path.

The air control unit 351 controls a flow of the compressed air in the air path. The air control unit 351 controls a flow velocity of the compressed air flowing through the air path using an air flow velocity control valve. In addition, the air control unit 351 opens and closes a flow path of the compressed air in the air path by using an air opening/closing control valve. In this way, the air control unit 351 controls the flow velocity and a flow rate of the compressed air flowing through the air path, and drives, for example, a blade of the slag chipper or the air cylinder portion 60 to be described later. The air control unit 351 operates based on a control command from the control device 80.

The temperature sensor amplifier 352 is electrically connected to a sensor cable of the temperature measuring device 40. The temperature sensor amplifier 352 amplifies a voltage output from a temperature sensor 50 to be described later via the sensor cable. Further, the temperature sensor amplifier 352 sends the amplified voltage to the control device 80. In the present embodiment, the control device 80 converts an input voltage value into a measurement temperature. However, the temperature sensor amplifier 352 may convert a voltage value acquired from the temperature measuring device 40 into a measurement temperature and send the measurement temperature to the control device 80.

### <Temperature Measuring Device 40>

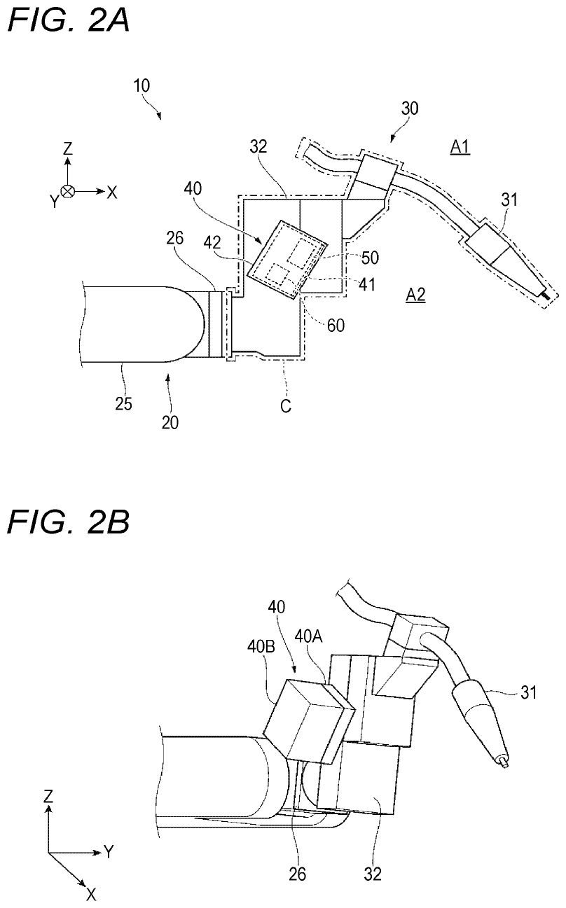

FIGS. 2A and 2B are enlarged views of portions including the tool portion 30 and the temperature measuring device 40 in the welding robot 10 in the reference posture as viewed from a Y-axis direction. FIG. 2A is a side view as viewed from an attachment surface side of the temperature measuring device 40, and FIG. 2B is a perspective view of the attachment surface side of the temperature measuring device 40 as viewed from an obliquely front side with respect to the X axis.

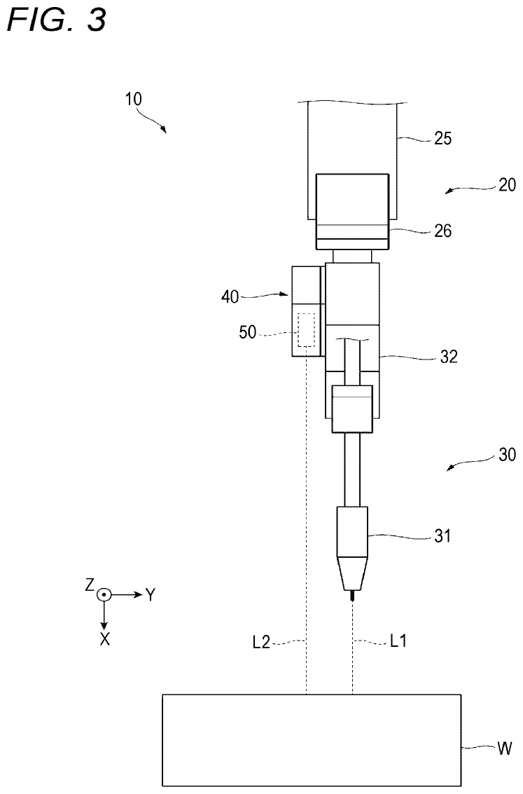

FIG. 3 is an enlarged plan view of the portions including the tool portion 30 and the temperature measuring device 40 in the welding robot 10 in the reference posture as viewed from a Z-axis direction.

As illustrated in FIGS. 2A and 2B, the temperature measuring device 40 is provided in a movable portion that moves the welding torch 31 in the welding robot 10, such as the manipulator portion 20 and the torch supporting portion 32 connected to the manipulator portion 20. The movable portion may be coupled to a tip end portion of the above-described arm having a plurality of drive shafts. Further, the temperature measuring device 40 of the present embodiment measures, in a predetermined period after one weld bead for a workpiece W is formed and before a next welding pass is welded to the workpiece W, a temperature of the one weld bead or a temperature of the workpiece W in the vicinity of the one weld bead. The temperature measuring device 40 of the present embodiment may measure both the temperature of the one weld bead and the temperature of the workpiece W in the vicinity of the one weld bead in the above-mentioned predetermined period.

Here, the above-described vicinity of the weld bead can be exemplified by, for example, a position within the workpiece W about 10 mm away from the weld bead formed on the workpiece W. Further, a position of the temperature measurement in the one weld bead can be exemplified by, for example, one position of a central portion in a longitudinal direction of the formed weld bead. The temperature measuring device 40 may measure temperatures of a plurality of different positions in the longitudinal direction of the weld bead of one welding pass. The same applies to a case where the temperature of the workpiece W in the vicinity of the weld bead is measured.

As illustrated in FIGS. 2A and 2B, the temperature measuring device 40 of the present embodiment is provided in the torch supporting portion 32 of the tool portion 30. As described above, the torch supporting portion 32 is connected to the wrist rotating portion 26 of the manipulator portion 20. Therefore, the temperature measuring device 40 is held by the wrist rotating portion 26 via the torch supporting portion 32. In this way, the temperature measuring device 40 is moved integrally with the welding torch 31 by the wrist rotating portion 26 which is an end of the manipulator portion 20.

In addition, in the welding robot 10 of the present embodiment, by providing the temperature measuring device 40 in the torch supporting portion 32 that supports the welding torch 31, a relative positional relation between the temperature measuring device 40 and the welding torch 31 is fixed.

Here, the welding robot 10 moves the welding torch 31 to a predetermined position with respect to the workpiece W to perform welding. In this case, it is necessary for the welding robot 10 to move the welding torch 31 such that a movable portion such as the torch supporting portion 32 that moves the welding torch 31 with respect to the workpiece W does not interfere with the workpiece W. That is, in the welding robot 10, movement of the welding torch 31 is restricted by an outer shape of the movable portion such as the torch supporting portion 32. For example, in order not to obstruct the movement of the welding torch 31 with respect to the workpiece W, it is preferable that structural portions other than the welding torch 31 and the torch supporting portion 32 are not provided in an upper region A1 and a lower region A2 in the vertical direction of the tool portion 30 as illustrated in FIG. 2A.

Here, as illustrated in FIG. 3, in the welding robot 10 of the present embodiment, when the welding robot 10 in the reference posture is viewed on an upper side in the Z-axis direction which is the vertical direction and from a direction which the manipulator portion 20 is along in the X-axis direction, the temperature measuring device 40 is disposed on one side in the left-right direction of the manipulator portion 20. In an example illustrated in FIG. 3, the temperature measuring device 40 is disposed on a left side as viewed toward the paper face in the torch supporting portion 32 when viewed from a welding torch 31 side. As described above, in the welding robot 10 in the reference posture, the temperature measuring device 40 of the present embodiment is disposed on a lateral side of the tool portion 30 in the left-right direction, not on the upper side in the vertical direction or the lower side in the vertical direction.

Further, as illustrated in FIG. 2A, the temperature measuring device 40 is provided on an inner side with respect to a contour C which is the outer shape of the tool portion 30 when the welding robot 10 in the reference posture is viewed from the Y-axis direction which is the horizontal direction. The temperature measuring device 40 does not protrude to the region A1 or the region A2 even in a state in which the temperature measuring device 40 is disposed on one side of the tool portion 30 in the left-right direction.

The temperature measuring device 40 is detachably attached to a plane defined by the X axis and the Z axis (hereinafter, also referred to as an “XZ plane”) of the torch supporting portion 32.

The temperature measuring device 40 includes a base 40A attached to the torch supporting portion 32 and a cover 40B openable and closable in the Y direction with respect to the base 40A. The cover 40B is a box-shaped member.

For example, the temperature sensor 50 and the air cylinder portion 60 are attached to the base 40A. The cover 40B is driven to open and close in the Y-axis direction with respect to the base 40A by the air cylinder portion 60. In a case where the interpass temperature is measured, the cover 40B is driven and controlled to be in an open state. On the other hand, in a case where the interpass temperature is not measured, the cover 40B is driven and controlled to be in a closed state.

When the cover 40B is driven and controlled to be in the open state, the temperature sensor 50 is exposed to the outside, and the temperature of the workpiece W can be measured. The temperature sensor 50 outputs information on the interpass temperature at the measurement position as a voltage. The temperature sensor 50 may be a known sensor that specifies temperatures of a weld bead to be measured and a workpiece W to be measured in the vicinity of the weld bead, and is preferably, for example, a non-contact sensor such as an infrared sensor. The temperature sensor 50 in the present embodiment can measure the interpass temperature in a range of 100° ° C. to 600° ° C., for example.

On the other hand, when the cover 40B is driven and controlled to be in the closed state, the temperature sensor 50 is shielded from the outside. By controlling the cover 40B to be in the closed state, the temperature sensor 50 is protected from spatter, fume, and radiant heat generated during welding. That is, the cover 40B functions as an openable protection mechanism that protects the temperature sensor 50 from the spatter or the like.

In a case of the present embodiment, an air ejection mechanism is also provided on an inner side of the cover 40B. The air ejection mechanism is known. Therefore, detailed descriptions of the air ejection mechanism will be omitted. An outlet port of air is directed toward a light receiving portion of the temperature sensor 50 so as to blow off dirt, dust, and the like adhering to the light receiving portion of the temperature sensor 50. Compressed air is supplied from the air compressor 70 to also the air ejection mechanism referred to herein, and the air ejection mechanism functions as a cleaning unit or an ejection mechanism of the temperature sensor 50.

In FIG. 3, a central axis L1 of the welding torch 31 and a measurement axis L2 of the temperature sensor 50 are indicated by broken lines.

In the example of FIG. 3, the welding torch 31 is positioned parallel to the X axis. In this case, the central axis L1 of the welding torch 31 coincides with an axis of the wire.

As illustrated in FIG. 3, an XZ plane including the central axis L1 of the welding torch 31 in the plane and an XZ plane including the measurement axis L2 of the temperature sensor 50 in the plane are distant by a certain distance in the Y-axis direction, and the temperature sensor 50 is attached to a side surface of the torch supporting portion 32 such that the XZ plane including the measurement axis L2 of the temperature sensor 50 in the plane is parallel to the XZ plane including the central axis L1 of the welding torch 31 in the plane.

Thus, by attaching the temperature sensor 50 to the side surface of the torch supporting portion 32, interference between the measurement axis L2 of the temperature sensor 50 and the central axis L1 of the welding torch 31 is avoided.

The range in which the temperature sensor 50 measures the interpass temperature is not a point but has a certain degree of spread. In the present embodiment, the range in which the temperature sensor 50 measures the interpass temperature is also referred to as a measurement field of view. The measurement field of view may be in a range of 7 mm to 48 mm in diameter, for example, 26 mm in diameter. The measurement axis L2 means the center of this range.

The temperature sensor 50 in the present embodiment is attached to the side surface of the torch supporting portion 32 with a low risk of interfering with surrounding members in a case where the temperature sensor 50 moves integrally with the welding torch 31. Therefore, even in a case where a posture of the welding robot 10 is controlled, the temperature sensor 50 is less likely to interfere with the workpiece W or the like. In addition, even in a case where the welding torch 31 is replaced with another tool, the temperature sensor 50 does not obstruct the replacement work. Further, by attaching the temperature sensor 50 to the side surface of the torch supporting portion 32, a distance between the temperature sensor 50 and a groove can be increased, and a possibility that the temperature sensor 50 is covered with spatter or fume generated during welding can be reduced accordingly.

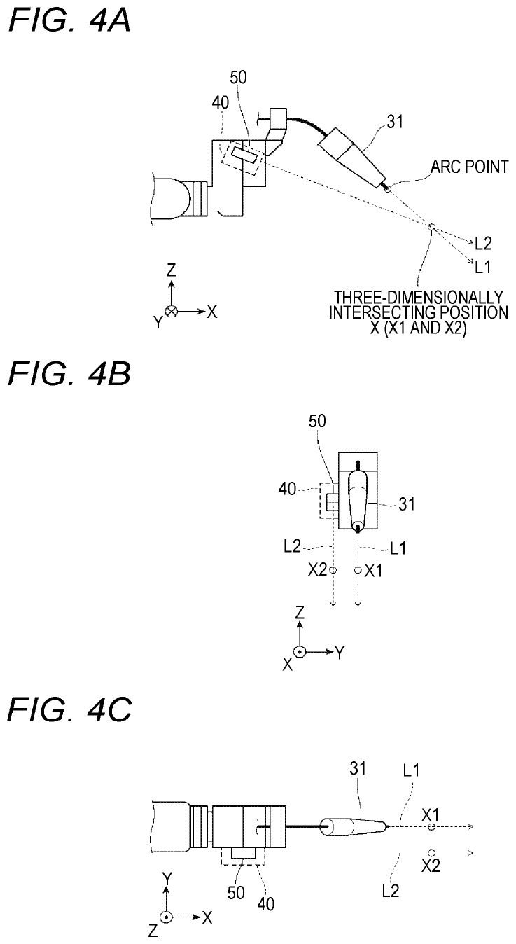

FIGS. 4A, 4B, and 4C are other views illustrating the positional relation between the central axis L1 of the welding torch 31 and the measurement axis L2 of the temperature sensor 50. FIG. 4A is a side view of the portions including the tool portion 30 and the temperature measuring device 40 in the welding robot 10 as viewed from the attachment surface side of the temperature measuring device 40. FIG. 4B is a front view of a portion including the welding torch 31 of the welding robot 10 as viewed from the front. FIG. 4C is a plan view of the portion of the welding torch 31 of the welding robot 10 as viewed from above.

In FIGS. 4A, 4B, and 4C, a tip end of the wire protruding from the welding torch 31 is referred to as a wire tip end position. As illustrated in FIGS. 4B and 4C, the central axis L1 and the measurement axis L2 are offset in the Y-axis direction. In other words, the XZ plane passing through the measurement axis L2 and the XZ plane passing through the central axis L1 are substantially parallel to each other.

On the other hand, an inclination of the central axis L1 is different from an inclination of the measurement axis L2 in the XZ plane. Therefore, the central axis L1 and the measurement axis L2 three-dimensionally intersect in the XZ plane. That is, the central axis L1 and the measurement axis L2 are positioned in a skew position, but are included in planes (XZ planes) parallel to each other, and the central axis L1 and the measurement axis L2 intersect at one point when viewed from a direction (Y direction) orthogonal to each of the planes (XZ planes). In FIGS. 4A, 4B, and 4C, a position at which the central axis L1 and the measurement axis L2 three-dimensionally intersect each other is expressed as a “three-dimensionally intersecting position X”. Hereinafter, a point on the central axis L1 corresponding to the “three-dimensionally intersecting position X” is referred to as X1, and a point on the measurement axis L2 corresponding thereto is referred to as X2. A three-dimensionally intersecting relation can also be seen on roads and railroads.

As described above, the central axis L1 of the welding torch 31 and the measurement axis L2 of the temperature sensor 50 satisfy a positional relation of being offset in the Y-axis direction as illustrated in FIGS. 4B and 4C. Therefore, a position of the measurement axis L2 in the Y-axis direction can be calculated based on coordinates of the wire tip end position. In addition, the central axis L1 of the welding torch 31 and the measurement axis L2 of the temperature sensor 50 satisfy a positional relation of three-dimensionally intersect with each other in the XZ plane as illustrated in FIGS. 4A, 4B, and 4C. Therefore, when coordinates of the point X1 are known based on the coordinates of the wire tip end position, it is possible to calculate coordinates at which the measurement axis L2 passing through the point X2 corresponding to the point X1 intersects a surface of the workpiece W. A distance between the wire tip end position and the point X1 can be calculated or measured in advance.

However, even when a predetermined position passing through the central axis L1 of the welding torch 31 is set as an origin and the origin is used instead of the wire tip end position, a distance between the origin and the point X1 can be calculated in the same manner. For example, even when a tip end position of a contact tip passing through the central axis L1 and provided in the welding torch 31 is set as the origin, the distance between the origin and the point X1 can be calculated or measured by using coordinates of the origin. In addition, even when a distance that passes through the central axis L1 and corresponds to a wire stick out from the tip end position of the contact tip is set as the origin, the distance between the origin and the point X1 can be calculated in the same manner by using coordinates of the origin. A distance corresponding to the wire stick out is, for example, 10 mm to 40 mm.

In addition, when a position of the point X1 is known, a position of the point X2 offset in the Y-axis direction is also known, so that the welding torch 31 can be easily moved such that the point X2 substantially coincides with the position at which the interpass temperature on the workpiece W is measured.

Further, when the position of the point X2 is adjusted such that a distance between the light receiving portion of the temperature sensor 50 and the point X2, that is, a measurement distance is within an appropriate range, an accuracy of the measured interpass temperature can be improved. The measurement distance is preferably set within a range of 500 mm to 1,100 mm.

In addition, when the interpass temperature is measured by substantially matching the position of the point X2 with the position at which the interpass temperature is measured on the workpiece W every time the interpass temperature is measured, the measurement distance when measuring the interpass temperature can be kept constant. As a result, a variation in errors superimposed on the measured interpass temperature can be reduced.

For example, in a case where a measurement distance used for a first measurement of the interpass temperature is 500 mm and a measurement distance used for a second measurement of the interpass temperature is 1,100 mm, even in a case where an actual interpass temperature on the workpiece W is the same, the measured interpass temperature may vary since a measurement condition is changed.

On the other hand, in a case where the measurement distance is kept constant as in the present embodiment, the accuracy of the measured interpass temperature is improved.

In a case where the interpass temperature at a predetermined position on the workpiece W is measured, the method is not limited to a method of substantially matching the point X2 with the predetermined position. For example, coordinates of a point where the measurement axis L2 of the temperature sensor 50 intersects the surface of the workpiece W may be calculated, and the welding torch 31 may be moved such that the coordinates of the same point substantially coincide with the predetermined position on the workpiece W. The coordinates of the point where the measurement axis L2 of the temperature sensor 50 intersects the surface of the workpiece W can be easily calculated by using the coordinates of the point X2.

The control device 80 used in the present embodiment is configured by, for example, a computer, and controls movement of one or more welding robots 10. In the case of the present embodiment, a dedicated device is used as the control device 80. However, the control device 80 may be a general-purpose computer.

The computer includes a calculation unit that executes a control program, a nonvolatile semiconductor memory that stores a startup program and the like, a volatile semiconductor memory in which the control program is executed, a hard disk drive that records various kinds of information collected from the welding robot 10 and the temperature sensor 50, and the like. The hard disk drive is an example of a storage unit.

An input device and a display device are also connected to the control device 80 as a computer.

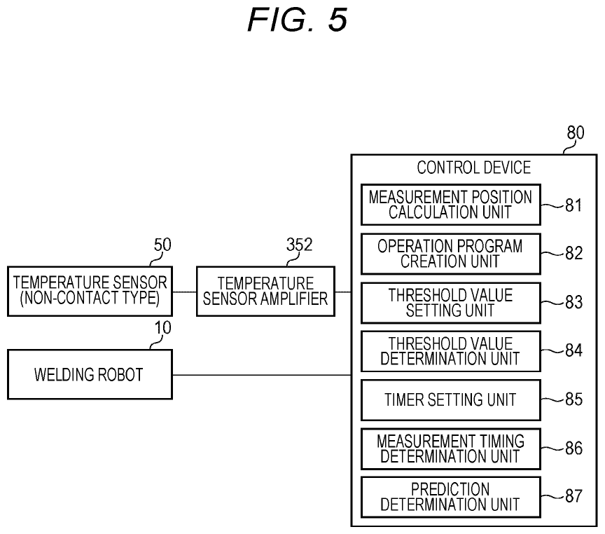

FIG. 5 is a block diagram illustrating functions of the control device 80. These functions are implemented through execution of an application program.

The control device 80 used in the present embodiment includes a measurement position calculation unit 81, an operation program creation unit 82, a threshold value setting unit 83, a threshold value determination unit 84, a timer setting unit 85, a measurement timing determination unit 86, and a prediction determination unit 87.

The measurement position calculation unit 81 referred to herein is a functional unit that calculates a position at which the interpass temperature is measured for each workpiece W to be welded. The measurement position calculation unit 81 calculates the position at which the interpass temperature is measured on the workpiece W based on data related to a shape of the workpiece W. The data related to the shape of the workpiece W includes dimension data of the workpiece W and shape data of the groove. The measurement position calculation unit 81 is an example of a calculation unit.

The dimension data of the workpiece W is given as three-dimensional data. The dimension data may be given as computer aided design (CAD) data or may be given by manual input. In the present embodiment, the CAD data is used to improve work efficiency.

The shape data of the groove may be measured by touch sensing of the surface of the groove by a wire touch sensor, may be acquired by using an image of the groove captured by a camera, or may be measured by a laser sensor.

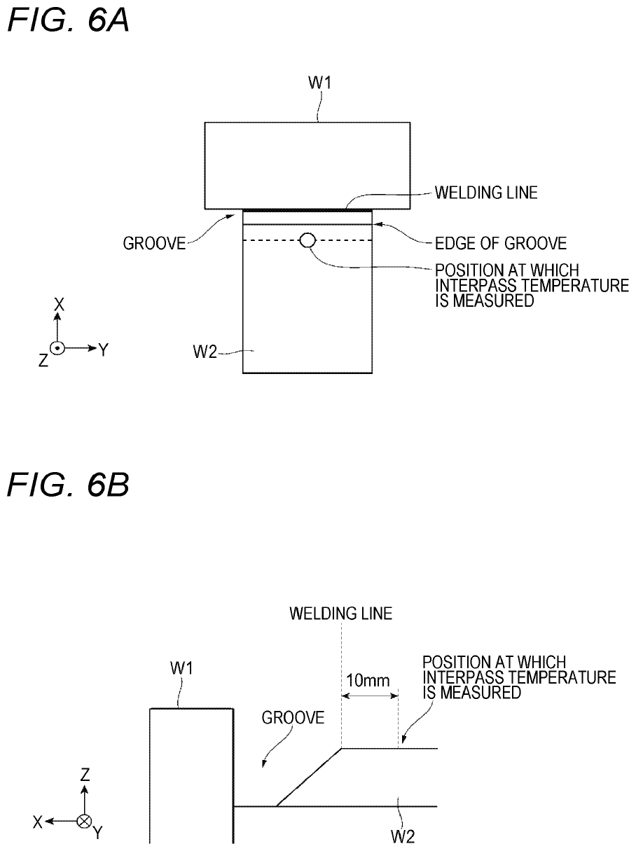

FIGS. 6A and 6B are views illustrating a position at which the interpass temperature is measured. FIG. 6A is a plan view of two workpieces W1 and W2 to be welded as viewed from the upper surface. FIG. 6B is a side view of the groove as viewed from a side surface side.

As illustrated in FIGS. 6A and 6B, the position at which the interpass temperature is measured is defined as a point distant from an edge of an upper end surface side of the groove only by a distance defined by a standard in a direction orthogonal to a welding line and in a direction away from the welding line. For example, in a case of JASS6, the position at which the interpass temperature is measured is defined as a point 10 mm away from the edge of the groove.

A distance from the workpiece W1 constituting a vertical surface of the groove to the edge of the groove provided on a workpiece W2 side can be calculated based on shape information of the groove by touch sensing or the like, a plate thickness of the workpiece W2, and the like.

In the case of FIG. 6A, only one position at which the interpass temperature is measured is illustrated, but there may be a plurality of positions at which the interpass temperature is measured. In some cases, the position at which the interpass temperature is measured may be any position on a workpiece designated by an operator.

The operation program creation unit 82 is a functional unit that creates an operation program for calculating the position at which the interpass temperature is measured calculated by the measurement position calculation unit 81, and measuring the interpass temperature by moving the welding torch 31 such that the measurement axis L2 of the temperature sensor 50 substantially coincides with the position at which the interpass temperature is measured, based on information on the calculated position and the relations illustrated in FIGS. 3, 4A, 4B, and 4C, that is, the positional relations between the central axis L1 of the welding torch 31 and the measurement axis L2 of the temperature sensor 50.

By using the operation program creation unit 82, teaching work by the operator is not required, and the work is made more efficient. In addition to, when the teaching work by the operator is not required, a time required for preparation for measuring the interpass temperature is also shortened.

The threshold value setting unit 83 is a functional unit that sets a threshold value for managing the interpass temperature. The threshold value referred to herein gives an upper limit value of the interpass temperature to be satisfied by the workpiece W before a next pass starts. In the case of the present embodiment, the threshold value is set by selecting one value from a range of 200° ° C. to 350° C., for example. The selection of the value may be performed by the operator, or an interpass temperature recommended according to information on the shape of the workpiece W or the like may be automatically set as the threshold value.

The threshold value determination unit 84 is a functional unit in which the temperature sensor 50 determines whether the interpass temperature exceeds the threshold value, and an operation corresponding to a determination result is instructed. The interpass temperature used for the determination may be a value instantaneously measured by the temperature sensor 50 (so-called instantaneous value) or an average value of values continuously acquired within a certain period of time.

In the case of the present embodiment, in a case where it is determined that the measured interpass temperature exceeds the threshold value, the threshold value determination unit 84 instructs at least one of an operation of waiting for a start of the next pass for a certain period of time, an operation of cooling the workpiece W, or an operation of executing work different from the next pass.

The operation of waiting for the start of the next pass for a certain period of time means naturally cooling the workpiece W. In addition, the operation of cooling the workpiece W means, for example, active cooling of the workpiece W by blowing air. Further, the operation of executing work different from the next pass means removal of slag, welding of another portion, or the like. While different work is executed, the workpiece W is naturally cooled.

In a case where any one or a plurality of the operations described above are instructed, the threshold value determination unit 84 measures the interpass temperature at the same position again after a predetermined time has elapsed due to the operation, and instructs resumption (continuation) of the next pass in a case where the measured interpass temperature is equal to or lower than the threshold value.

In a case where the measured interpass temperature is equal to or lower than the threshold value, the threshold value determination unit 84 records data related to the measurement in a hard disk drive or the like. In addition to the measured interpass temperature, the data related to the measurement referred to herein includes a date and time of the measurement, an outside air temperature, a time for waiting for the next pass, a time for cooling the workpiece W, a time for executing work different from the next pass, and the like.

The data related to the measurement described above may be recorded in a hard disk drive or the like in association with data related to the shape of the workpiece W and welding condition data. These pieces of data include set values and actual measurement values.

The data related to the shape of the workpiece W and the welding condition data are recorded in advance in a hard disk drive or the like.

In addition, every time the interpass temperature is newly measured, the newly acquired data related to the measurement of the interpass temperature may be recorded in the hard disk drive or the like in association with the data related to the shape of the workpiece W and the welding condition data.

The timer setting unit 85 is a functional unit that instructs measurement of the interpass temperature at the measurement position only immediately before a specific pass.

In the case of the present embodiment, measurement of the interpass temperature is executed each time immediately before one pass is started. However, in a case where it is desired to skip the measurement of the interpass temperature, it is possible to set a timer instead of measuring the interpass temperature. In this case, the timer setting unit 85 can instruct to measure the interpass temperature only immediately before the predetermined pass and skip measurement of the interpass temperature in other passes.

By measuring the interpass temperature only at a necessary timing, a work time required for the measurement of the interpass temperature can be shortened. The timer is set by, for example, the operator.

The measurement timing determination unit 86 is a functional unit having: a function of comparing data related to the shape of the workpiece W and welding condition data in the past which are recorded in advance in a hard disk drive or the like with data related to the shape of the workpiece W and welding condition data which are at current; a function of determining a timing of a next measurement of the interpass temperature using a comparison result; and a function of instructing the measurement of the interpass temperature.

In the case of the timer setting unit 85 described above, the operator sets the timing of measuring the interpass temperature, but the measurement timing determination unit 86 automatically determines the timing of the measurement by comparing the past data with the current data.

For example, in a case where it is confirmed that the data related to the shape of the workpiece W and the welding condition data are the same between the past data and the current data, and that in the past data, each interpass temperature measured immediately before a second pass and a third pass is equal to or lower than the threshold value, the measurement timing determination unit 86 determines to execute the measurement of the interpass temperature at a timing at which the interpass temperature is expected to be equal to or lower than the threshold value.

With this function, the measurement of the interpass temperature is executed at an appropriate timing, and the work time required for the measurement of the interpass temperature can be shortened. In addition, since the necessary timing can be automatically determined, a burden on the operator is reduced.

The prediction determination unit 87 is a functional unit that automatically predicts the time required for cooling in a case where the threshold value determination unit 84 determines that the interpass temperature exceeds the threshold value. The prediction determination unit 87 is an example of a prediction unit.

The prediction determination unit 87 in the present embodiment is a functional unit having: a function of comparing at least one of the data related to the measurement of the interpass temperature, the data related to the shape of the workpiece W, or the welding condition data in the past which are recorded in advance in the hard disk drive or the like with at least one of data related to the measurement of the interpass temperature, data related to the shape of the workpiece W, or welding condition data which are newly recorded in a current measurement; and a function of instructing whether to execute waiting by predicting a waiting time necessary for natural cooling or to execute cooling of the workpiece W by predicting a necessary cooling time in a case where the waiting time or the cooling time can be predicted based on a result of a comparison.

In a case where the predicted waiting time or the predicted cooling time is equal to or longer than a certain period of time determined in advance, the prediction determination unit 87 instructs execution of work different from the next pass. With this function, a timing of re-measuring the interpass temperature is optimized, and a time until re-measuring the interpass temperature is shortened.

The prediction determination unit 87 may be provided with a function of calculating a value of a difference between the measured interpass temperature and the threshold value in a case where the prediction determination unit 87 determines that the measured interpass temperature exceeds the threshold value, and determining and instructing which of waiting for the start of the next pass, cooling of the workpiece W, and work different from the next pass is to be executed according to the calculated value of the difference.

For example, the prediction determination unit 87 is provided with a function of instructing cooling of the workpiece W in a case where a temperature difference between the measured interpass temperature and the threshold value is 200° C., and instructing natural cooling of the workpiece W in a case where the temperature difference is 100° C.

With this function, it is possible to instruct an appropriate operation corresponding to the temperature difference between the measured interpass temperature and the threshold value, and improvement in work efficiency is realized.

In a case where the operation to be instructed is determined, not only the temperature difference between the measured interpass temperature and the threshold value but also information on the dimension and shape of the workpiece W may be included. The reason is that, when dimensions and the like of workpieces W are different, there is a possibility that a difference occurs in a progress of the cooling even when an initial temperature difference is the same. For example, the interpass temperature of a workpiece W having a large dimension may decrease earlier than that of a workpiece W having a small dimension. Therefore, when the operation to be instructed, the waiting time, and the like are determined according to the dimension and the like of the workpiece W in addition to the temperature difference between the measured interpass temperature and the threshold value, it is possible to select an operation more suitable for the workpiece W and further improve the work efficiency.

### <Measurement Process of Interpass Temperature>

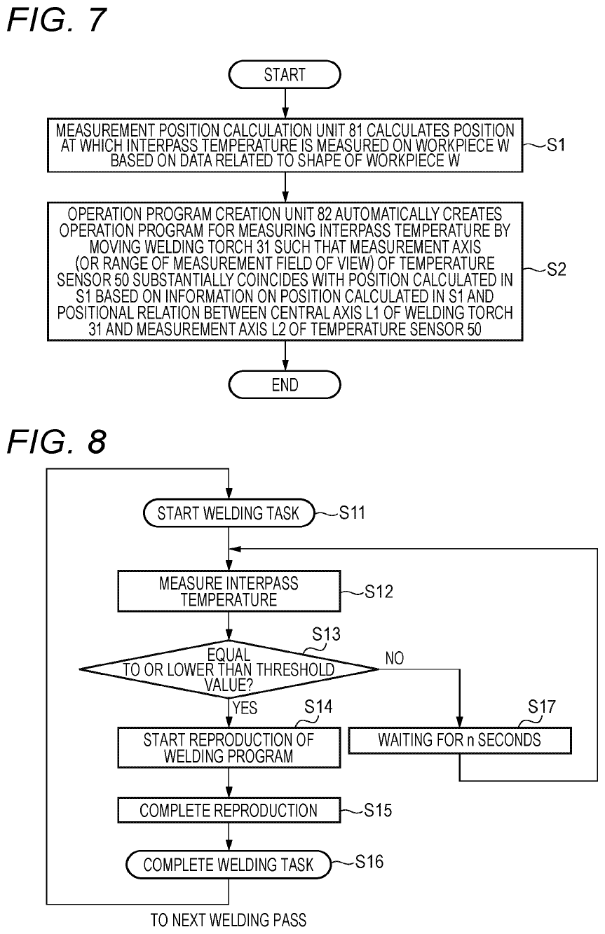

FIG. 7 is a flowchart illustrating an example of operations of a process executed before welding by the welding system 1 is started. An S symbol illustrated in the drawing means a step.

First, the measurement position calculation unit 81 calculates a position at which the interpass temperature is measured on the workpiece W based on the data related to the shape of the workpiece W (step 1).

Next, the operation program creation unit 82 automatically creates an operation program for measuring the interpass temperature by moving the welding torch 31 such that the measurement axis L2 of the temperature sensor 50 substantially coincides with the position calculated in step 1 based on the information on the position calculated in step 1 and the positional relation between the central axis L1 of the welding torch 31 and the measurement axis L2 of the temperature sensor 50 (step 2).

When the above process is completed, the interpass temperature can be measured by the created operation program.

FIG. 8 is a flowchart illustrating an execution example of a welding operation using the welding system 1. An S symbol illustrated in the drawing means a step.

First, a welding task is started (step 11). When the welding task is started, the welding robot 10 moves the welding torch 31 to a predetermined position of the groove under control of the control device 80, and starts welding.

When one pass is completed, the measurement of the interpass temperature is executed (step 12). In step 12, the control device 80 moves the welding torch 31 such that the measurement axis L2 of the temperature sensor 50 is moved to a position for measuring the interpass temperature on the workpiece W in accordance with an operation program created in advance. When the movement is completed, the control device 80 calculates the interpass temperature based on a voltage difference measured by the temperature sensor 50.

Next, the control device 80 determines whether the measured interpass temperature is equal to or lower than a threshold value (step 13).

In a case where the interpass temperature is equal to or lower than the threshold value, the control device 80 obtains a positive result in step 13. In this case, the control device 80 records the measured interpass temperature, a measurement date and time, and the like in a hard disk drive or the like, and starts reproduction of the welding program (step 14). In a case where the reproduction of the welding program is completed (step 15), the control device 80 ends the welding task (step 16) and proceeds to a next pass.

On the other hand, in a case where the interpass temperature exceeds the threshold value, the control device 80 obtains a negative result in step 13. In this case, the control device 80 waits for, for example, n seconds to start the next pass (step 17), and then measures the interpass temperature again (step 12).

In step 17, instead of waiting, cooling of the workpiece W or execution of another work may be selected. In step 12, the timer setting unit 85 or the measurement timing determination unit 86 described above may be used to perform different work before measuring the interpass temperature in a part of the pass.

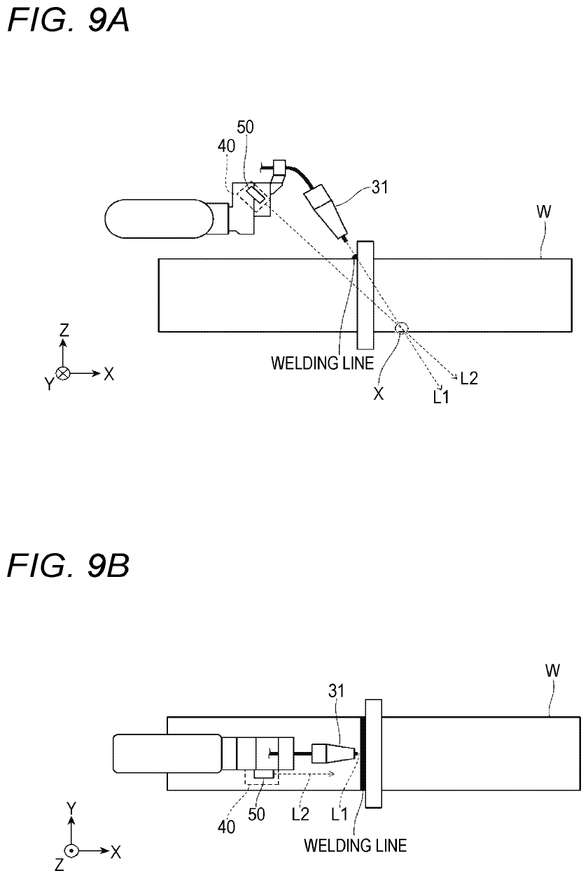

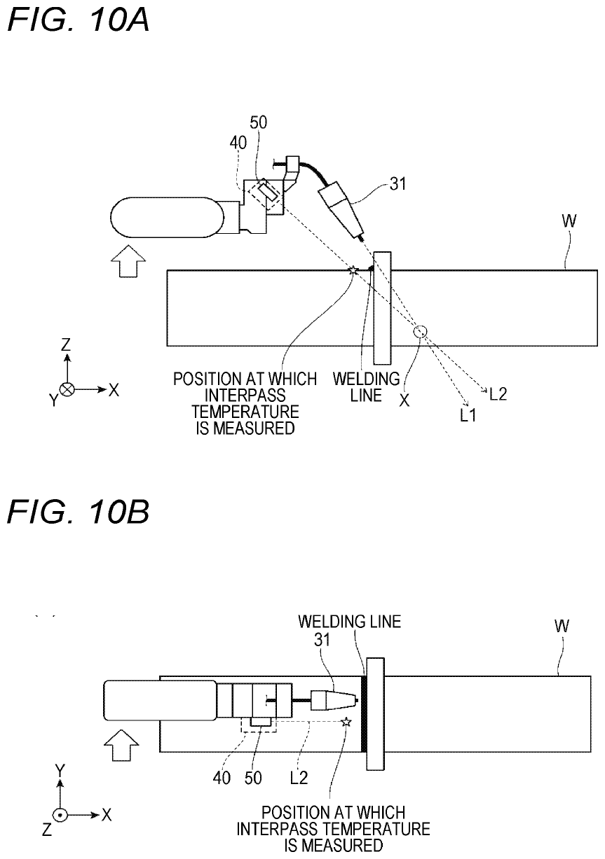

FIGS. 9A, 9B, 10A, and 10B illustrate operation examples of the welding robot 10 executed when measuring the interpass temperature by the welding system 1 used in the embodiment.

FIGS. 9A and 9B are views illustrating a positional relation between the workpiece W and the welding torch 31 or the like at the time when one pass is completed. FIG. 9A is a side view of the welding torch 31 or the like as viewed from the attachment surface side of the temperature sensor 50. FIG. 9B is a plan view of the welding torch 31 or the like as viewed from the upper surface. The central axis L1 of the welding torch 31 is positioned on the welding line.

In FIGS. 9A and 9B, the measurement axis L2 of the temperature sensor 50 is also drawn, but temperature measurement is not performed during welding. Actually, the cover 40B during welding is in the closed state. The position where the measurement axis L2 intersects the surface of the workpiece W is closer to a wrist rotating portion 26 side than the position used for measuring the temperature.

FIGS. 10A and 10B are views illustrating adjustment of the position of the welding torch 31 or the like in a case of measuring the interpass temperature. FIG. 10A is a side view of the welding torch 31 or the like as viewed from the attachment surface side of the temperature sensor 50. FIG. 10B is a plan view of the welding torch 31 or the like as viewed from the upper surface. In FIGS. 10A and 10B, portions corresponding to those in FIGS. 9A and 9B are denoted by corresponding reference signs.

In position alignment of the measurement axis L2, an operation of moving the welding torch 31 or the like in the Z-axis direction as illustrated in FIG. 10A and an operation of moving the welding torch 31 or the like in the Y-axis direction as illustrated in FIG. 10B are performed.

Since both the temperature sensor 50 and the welding torch 31 are fixedly attached to the torch supporting portion 32, the positional relation between the central axis L1 of the welding torch 31 and the measurement axis L2 of the temperature sensor 50 remains unchanged even when the torch supporting portion 32 moves. Therefore, the temperature sensor 50 also moves by an amount of movement of the welding torch 31 in a space in the Z-axis direction. When the temperature sensor 50 moves in the Z-axis direction in the space, the measurement axis L2 also moves in the same manner. As a result, along with the movement of the temperature sensor 50 in the Z-axis direction, a position where the measurement axis L2 intersects the surface of the workpiece W is moved in a direction approaching the welding line. Since the movement of the measurement axis L2 is parallel movement, the amount of movement on the workpiece W of the position where the measurement axis L2 intersects the surface of the workpiece W can be easily calculated. The movement of the temperature sensor 50 in the space in the Z-axis direction is controlled such that the position where the measurement axis L2 intersects the surface of the workpiece W reaches a point 10 mm away from the edge of the groove. This movement is also managed by the operation program.

Similarly, the welding torch 31 is moved also in a direction in which the welding line extends. In the case of FIGS. 10A and 10B, the direction in which the welding line extends is the Y-axis direction. The movement of the welding torch 31 is controlled such that the measurement axis L2 reaches a predetermined position for measuring the temperature. An offset length between the central axis L1 of the welding torch 31 and the measurement axis L2 of the temperature sensor 50 in an extending direction of the welding line is a value incorporated in software in accordance with a design of a sensor unit. In addition, the movement referred to herein is also parallel movement. Therefore, the amount of movement on the workpiece W of the position where the measurement axis L2 intersects the surface of the workpiece W can also be easily calculated.

As illustrated in FIGS. 10A and 10B, in the case of the present embodiment, the adjustment of the position of the measurement axis L2 necessary for measuring the interpass temperature is performed only by movement in two directions of the Z-axis direction and the Y-axis direction. Moreover, distances required for these movement are shorter than that in a comparative example to be described later. In other words, a time required for the movement is shortened, and a time until the measurement of the temperature is started is shortened. In addition, as illustrated in FIGS. 10A and 10B, since the temperature sensor 50 is attached to a side surface of the torch supporting portion 32 that supports the welding torch 31, when the welding torch 31 or the like move along with the measurement of the interpass temperature, the risk of the temperature sensor 50 interfering with the surrounding members such as the workpiece W is low.

### Comparative Example

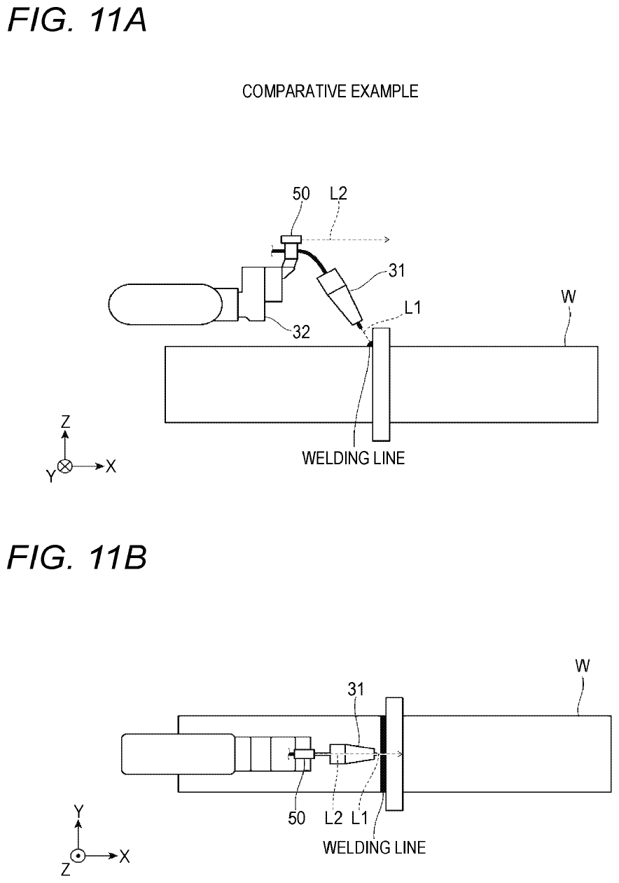

For reference, the operation at the time of measuring the interpass temperature in the welding system described in Patent Literature 1 will be described with reference to FIGS. 11A, 11B, 12A, 12B, 13A, and 13B.

FIGS. 11A and 11B are views illustrating a positional relation between the workpiece W and the welding torch 31 or the like at the time when one pass is completed in the welding system of the comparative example. FIG. 11A is a side view of the welding torch 31 or the like as viewed from the same side as FIG. 9A. FIG. 11B is a plan view of the welding torch 31 or the like as viewed from the upper surface.

In FIGS. 11A and 11B, portions corresponding to those in FIGS. 9A and 9B are denoted by corresponding reference signs.

In the case of FIGS. 11A and 11B, the temperature sensor 50 is attached to the upper surface of the torch supporting portion 32. That is, the temperature sensor 50 is attached at a position higher than the welding torch 31. In the example of FIGS. 11A and 11B, the temperature sensor 50 is attached to the torch supporting portion 32 such that the measurement axis L2 is parallel to the surface of the workpiece W. In this case, the welding torch 31 is positioned directly below the measurement axis L2 of the temperature sensor 50. Therefore, the welding torch 31 becomes an obstacle, and the interpass temperature cannot be measured from the position of the temperature sensor 50.

In the case of FIGS. 11A and 11B, the temperature sensor 50 is close to the welding torch 31, and it is difficult to replace the welding torch 31 with another tool. In addition, the upper surface of the torch supporting portion 32 is easily exposed to spatter or fume during welding. As a result, the temperature sensor 50 is likely to fail, and an error is likely to appear in measurement due to contamination.

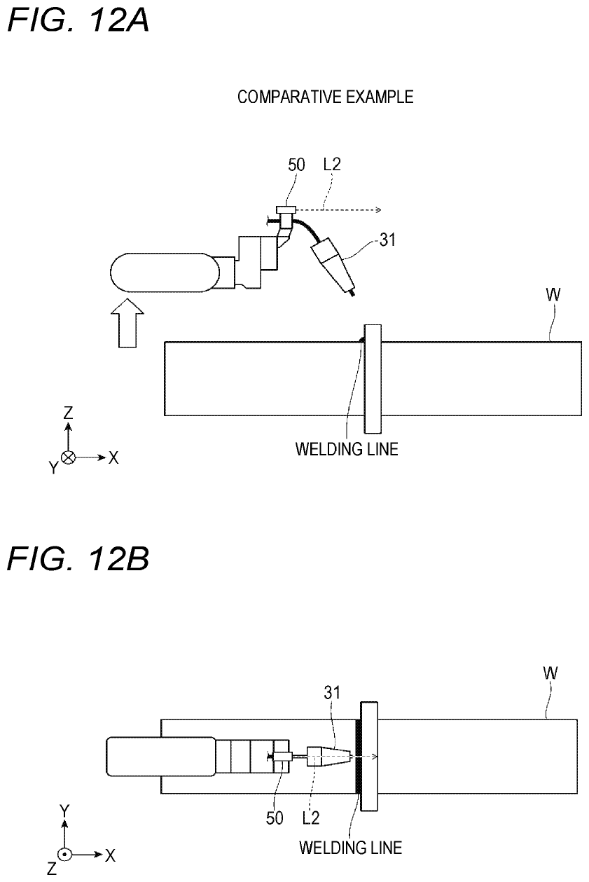

FIGS. 12A and 12B are views illustrating adjustment of the position of the welding torch 31 or the like in a case of measuring the interpass temperature in the welding system of the comparative example. FIG. 12A is a side view of the welding torch 31 or the like as viewed from the same side as FIG. 10A. FIG. 12B is a plan view of the welding torch 31 or the like as viewed from the upper surface. In FIGS. 12A and 12B, portions corresponding to those in FIGS. 11A and 11B are denoted by corresponding reference signs.

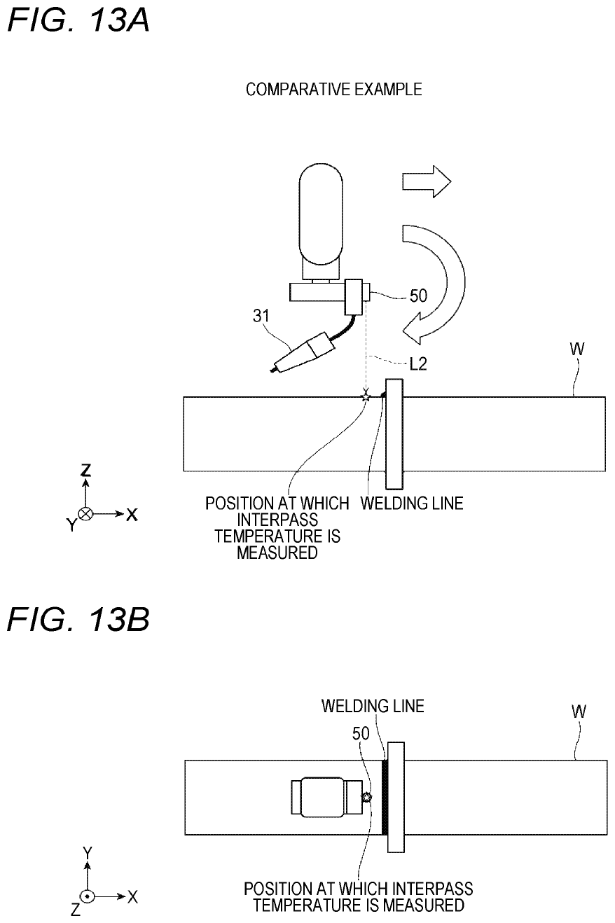

As illustrated in FIG. 12A, the welding torch 31 or the like are moved in the Z-axis direction. The movement referred to herein needs to be performed to reach a height at which the welding torch 31 does not interfere with the workpiece W in a case where the welding torch 31 or the like is rotated as illustrated in FIG. 13A. Therefore, a distance of movement in the Z-axis direction is longer than that in the embodiment illustrated in FIG. 10A.

FIGS. 13A and 13B are views illustrating an operation of directing the measurement axis L2 of the temperature sensor 50 to a position used for measuring the interpass temperature in the welding system of the comparative example. FIG. 13A is a side view of the welding torch 31 or the like as viewed from the same side as FIG. 10A. FIG. 13B is a plan view of the welding torch 31 or the like as viewed from the upper surface. In FIGS. 13A and 13B, portions corresponding to those in FIGS. 12A and 12B are denoted by corresponding reference signs.

In order to direct the measurement axis L2 of the temperature sensor 50 to the measurement point of the interpass temperature, as illustrated in FIG. 13A, it is necessary to rotate the welding torch 31 or the like by 90 degrees. This 90-degree rotational movement is an unnecessary operation in the embodiment. In addition, in a case where the 90-degree rotational movement is involved, movement of the arm or the like becomes large, and the time required for the position alignment becomes longer than that of the embodiment. In addition, a distance between the temperature sensor 50 and the workpiece W is likely to increase, and the accuracy of the measured interpass temperature is lower than that in the embodiment.

### Other Embodiments

Although the embodiment of the present invention has been described above, the technical scope of the present invention is not limited to the scope described in the above-described embodiment. It is apparent from the description of the scope of claims that various modifications or improvements made to the above-described embodiment are also included in the technical scope of the present invention.

For example, in the above-described embodiment, in a case where the measured interpass temperature exceeds the threshold value, the next pass is resumed after the process of waiting for the interpass temperature of the workpiece W to decrease or the like, but the welding itself may be stopped, or an alarm may be output through a sound, a lamp, or the like.

In the above-described embodiment, it is assumed that an angle formed by the central axis L1 of the welding torch 31 and the measurement axis L2 of the temperature sensor 50 (see FIG. 4A) is determined in advance, but the formed angle may be set adjustable. In this case, a mechanism for adjusting the angle is used. A mechanism for physically adjusting the angle includes, for example, a rod that adjusts the angle of the light receiving portion of the temperature sensor 50, a base that allows the angle of the main body of the temperature sensor 50 to change, and other members. In addition, a mechanism for optically adjusting the angle includes a lens or the like that the light receiving portion of the temperature sensor 50 disposes on the light path of light reception. The mechanism for adjusting the angle is used in a case of setting an initial position or in a case that a shift during use is required to be adjusted.

In the above-described embodiment, the temperature sensor 50 is attached to a side surface on a right side of the torch supporting portion 32 in a case where observed from the torch supporting portion 32 side toward the tip end direction of the welding torch 31, but the temperature sensor 50 may be attached to a side surface on a left side thereof.

In addition, an attachment position of the temperature sensor 50 may be on a front side or a lower surface side of the torch supporting portion 32 as long as the relation illustrated in FIGS. 4A, 4B, and 4C is satisfied. However, the condition is that the temperature sensor 50 does not interfere with the movement of the welding torch 31 during welding or the workpiece W.

In addition, in the above-described embodiment, the measurement axis L2 of the temperature sensor 50 is parallel to the central axis L1 of the welding torch 31 as illustrated in FIG. 3, but may not be parallel in a strict sense. However, parallel attachment facilitates the calculation of the point at which the measurement axis L2 of the temperature sensor 50 intersects the surface of the workpiece W.

In the case of the above-described embodiment, creation of the operation program illustrated in FIG. 7 is executed before the welding operation is started, but the creation may be executed every time the interpass temperature is measured. In addition, in the case of the above-described embodiment, the welding robot 10 is assumed to be a steel frame welding robot used for welding a steel frame, but the welding robot 10 is not limited to the steel frame welding robot as long as the welding robot 10 is an application in which measurement of the interpass temperature is required. Further, in the above-described embodiment, an example in which the welding robot 10 is an articulated robot has been described, but the welding robot 10 may be a single-articulated robot.

Although various embodiments have been described above with reference to the drawings, it is needless to say that the present invention is not limited to such examples. It will be apparent to those skilled in the art that various alterations and modifications can be conceived within the scope described in claims, and it should be understood that they also justifiably belong to the technical scope of the present invention. Each component in the embodiments described above may be combined arbitrarily in the range without deviating from the spirit of the invention.

The present application is based on a Japanese patent application (Patent Application No. 2021-071100) filed on Apr. 20, 2021, the contents of which are incorporated in the present application by reference.

### REFERENCE SIGNS LIST

1: welding system
10: welding robot
30: tool portion
31: welding torch
32: torch supporting portion
40: temperature measuring device
40A: base
40B: cover
50: temperature sensor
80: control device
81: measurement position calculation unit
82: operation program creation unit
83: threshold value setting unit
84: threshold value determination unit
85: timer setting unit
86: measurement timing determination unit
87: prediction determination unit
L1: central axis
L2: measurement axis

1. A welding system comprising:
a welding robot having a movable portion configured to move integrally with a welding torch;
a control device configured to control movement of the welding robot; and
a temperature sensor that is attached to the movable portion and is configured to measure an interpass temperature of an object to be welded present on a measurement axis in a noncontact manner, wherein
a central axis of the welding torch and the measurement axis of the temperature sensor are in a relation of three-dimensionally intersecting in a space, and a position where the central axis of the welding torch and the measurement axis of the temperature sensor three-dimensionally intersect is ahead of a tip end of the welding torch on the central axis of the welding torch, and
the control device is configured to control movement of the welding torch such that the measurement axis of the temperature sensor is positioned at a measurement position of the interpass temperature calculated in advance.

2. The welding system according to claim 1, wherein
the control device further includes a calculation unit configured to calculate the measurement position based on data related to a shape of the object to be welded.

3. The welding system according to claim 1, further comprising:
an openable protection mechanism configured to cover the temperature sensor during welding and expose at least a light receiving portion during measurement of the interpass temperature, and/or an ejection mechanism configured to eject air for cleaning the light receiving portion of the temperature sensor.

4. The welding system according to claim 2, further comprising:
an openable protection mechanism configured to cover the temperature sensor during welding and expose at least a light receiving portion during measurement of the interpass temperature, and/or an ejection mechanism configured to eject air for cleaning the light receiving portion of the temperature sensor.

5. The welding system according to claim 1, wherein
the control device is configured to instruct measurement of the interpass temperature at the measurement position only immediately before a specific pass.

6. The welding system according to claim 2, wherein
the control device is configured to instruct measurement of the interpass temperature at the measurement position only immediately before a specific pass.

7. The welding system according to claim 3, wherein
the control device is configured to instruct measurement of the interpass temperature at the measurement position only immediately before a specific pass.

8. The welding system according to claim 1, wherein
the control device further includes
a setting unit configured to set a threshold value to be used for management of the interpass temperature at the measurement position, and
a determination unit configured to determine whether the interpass temperature measured by the temperature sensor exceeds the threshold value, and
the control device is configured to
execute at least one or more of waiting for a start of a next pass, cooling of the object to be welded, or execution of a work different from the next pass in a case where the measured interpass temperature exceeds the threshold value, and
subsequently instruct resumption of the next pass in a case where the interpass temperature measured again is equal to or lower than the threshold value.

9. The welding system according to claim 8, wherein
in a case where the determination unit determines that the measured interpass temperature is equal to or lower than the threshold value, data related to measurement including the measured interpass temperature is recorded in a storage unit.

10. The welding system according to claim 8, wherein
the control device is configured to
compare past data related to a shape of the object to be welded and welding condition past data which are recorded in advance with current data related to the shape of the object to be welded and welding condition current data which are at current, determine a timing of measurement of an interpass temperature related to a specific pass, and instruct the measurement of the interpass temperature.

11. The welding system according to claim 8, wherein
the control device further includes a prediction unit configured to,
in a case where the determination unit determines that the measured interpass temperature exceeds the threshold value,
compare at least one or more of past data related to the measurement, past data related to the shape of the object to be welded, or welding condition past data in the past which are recorded in advance with at least one or more of current data related to the measurement, current data related to the shape of the object to be welded, or welding condition current data which are newly recorded in a current measurement, and
in a case where a waiting time or a cooling time can be predicted based on a comparison result,
predict the waiting time required for natural cooling and instruct waiting until the start of a next pass, or predict the cooling time required and instruct cooling of the object to be welded, or
instruct execution of a work different from the next pass in a case where the predicted waiting time or the predicted cooling time is equal to or longer than a certain period of time.

12. The welding system according to claim 8, wherein
in a case where the determination unit determines that the measured interpass temperature exceeds the threshold value, the determination unit is configured to calculate a value of a difference between the measured interpass temperature and the threshold value, and determine and instruct which of waiting for the start of the next pass, cooling of the object to be welded, and a work different from the next pass is to be executed according to the calculated value of the difference.

13. The welding system according to claim 1, wherein
the movable portion is coupled to a tip end portion of an arm having a plurality of drive shafts.

14. The welding system according to claim 8, wherein
the movable portion is coupled to a tip end portion of an arm having a plurality of drive shafts.

15. A welding robot comprising:
a movable portion configured to move integrally with a welding torch; and
a temperature sensor that is attached to the movable portion and is configured to measure an interpass temperature of an object to be welded present on a measurement axis in a noncontact manner, wherein
a central axis of the welding torch and the measurement axis of the temperature sensor are in a relation of three-dimensionally intersecting in a space, and a position where the central axis of the welding torch and the measurement axis of the temperature sensor three-dimensionally intersect is ahead of a tip end of the welding torch on the central axis of the welding torch.

16. A welding method using a welding system comprising:
a process of measuring an interpass temperature at a measurement position using the welding system according to claim 1;
a process of continuing a next pass in a case where the measured interpass temperature is equal to or lower than a threshold value; and
a process of measuring the interpass temperature at the measurement position one or more times after a predetermined time elapses in a case where the measured interpass temperature exceeds the threshold value, and instructing to start the next pass after the measured interpass temperature becomes equal to or lower than the threshold value.

17. A welding method using a welding system comprising:
a process of measuring an interpass temperature at a measurement position using the welding system according to claim 8;
a process of continuing a next pass in a case where the measured interpass temperature is equal to or lower than a threshold value; and
a process of measuring the interpass temperature at the measurement position one or more times after a predetermined time elapses in a case where the measured interpass temperature exceeds the threshold value, and instructing to start the next pass after the measured interpass temperature becomes equal to or lower than the threshold value.

18. A non-transitory computer readable storage medium storing a program for causing a computer to execute a process, the process comprising:
measuring an interpass temperature at a measurement position using the welding system according to claim 1,
continuing a next pass in a case where the measured interpass temperature is equal to or lower than a threshold value, and
measuring the interpass temperature at the measurement position one or more times after a predetermined time elapses in a case where the measured interpass temperature exceeds the threshold value, and instructing to start the next pass after the measured interpass temperature becomes equal to or lower than the threshold value.

19. A non-transitory computer readable storage medium storing a program for causing a computer to execute a process, the process comprising:
measuring an interpass temperature at a measurement position using the welding system according to claim 8,
continuing a next pass in a case where the measured interpass temperature is equal to or lower than a threshold value, and
measuring the interpass temperature at the measurement position one or more times after a predetermined time elapses in a case where the measured interpass temperature exceeds the threshold value, and instructing to start the next pass after the measured interpass temperature becomes equal to or lower than the threshold value.
